(19) United States
(12) Patent Application Publication
(10) Pub. No.: US 2006/0068245 A1
(43) Pub. Date: Mar. 30, 2006

(54) Rechargeable fuel cell module

(76) Inventor: Rajiv K. Mongia, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/954,383

(22) Filed: Sep. 29, 2004

(51) Int. Cl. H01M 8/04; H01M 8/18

(52) U.S. Cl. 429/17; 429/19

(57) ABSTRACT

A method, system, and apparatus are disclosed. In one embodiment the method comprises capturing at least a portion of a reaction product of an operating fuel cell and converting at least a portion of the captured reaction product by utilizing an external source of electricity to create fuel that is stored back into the fuel cell's stored fuel supply.

### FIELD OF THE INVENTION

The invention relates to fuel cells. More specifically, the invention relates to recharging a fuel cell with a part of the fuel cell's expelled reaction product.

### BACKGROUND OF THE INVENTION

Fuel cells are becoming a popular alternate energy source for many consumer products today. A fuel cell is an electrochemical device similar to a battery. One major difference between a battery and a fuel cell is that the battery is limited to the internal energy stored within the battery, whereas a fuel cell is designed to produce electricity from an external fuel supply. Reactants, the substances that exist at the start of a chemical reaction, flow into the fuel cell and form one or more reaction products, which flow out. Along with the reaction product(s), the chemical reaction also produces electricity. Typical reactants used in a fuel cell are hydrogen on the anode side and oxygen on the cathode side (a hydrogen cell), although other reactants can also be used such as a number of different hydrocarbons (e.g. methanol, ethanol, etc). Fuel cells have been developed for use in transportation, homes, and in the workplace. One recent area of fuel cell development has been in mobile electronic devices such as laptop computers and handheld devices.

A major downside to integrating fuel cell technology into mobile electronic devices has been the need to refuel the devices with the reactant chemical(s). A mobile electronic device with a fuel cell would require frequent fill-ups, somewhat similar to the frequency of plugging the same device into a wall-outlet to recharge a conventional battery. The infrastructure necessary to create an efficient and easily accessible refueling system for devices as numerous as cell phones, laptop computers, and personal digital assistants (PDAs) is not practical. Furthermore, hydrogen or hydrocarbon fuels necessary for different types of fuel cells are not entirely safe or sensible to store or transport in environments such as in the home or at work while allowing the fuel to remain as accessible as electricity.

### BRIEF DESCRIPTION OF THE DRAWINGS

The present invention is illustrated by way of example and is not limited by the figures of the accompanying drawings, in which like references indicate similar elements, and in which:

FIG. 1 illustrates one embodiment of a mobile computing device containing a rechargeable fuel cell module.

FIG. 2 illustrates one embodiment of a rechargeable fuel cell module.

FIG. 3 is a flow diagram of one embodiment of a process to recharge a fuel cell's fuel supply with at least a portion of a reaction product expelled from the operating fuel cell.

FIG. 4 is a flow diagram of another embodiment of a process to recharge a fuel cell's fuel supply with at least a portion of a reaction product expelled from the operating fuel cell.

### DETAILED DESCRIPTION OF THE INVENTION

Embodiments of an effective method to recharge a fuel cell's fuel supply with a portion of one or more reaction products expelled from the operating fuel cell are disclosed. In the following description, numerous specific details are set forth. However, it is understood that embodiments may be practiced without these specific details. In other instances, well-known elements have not been discussed in detail in order to avoid obscuring the present invention.

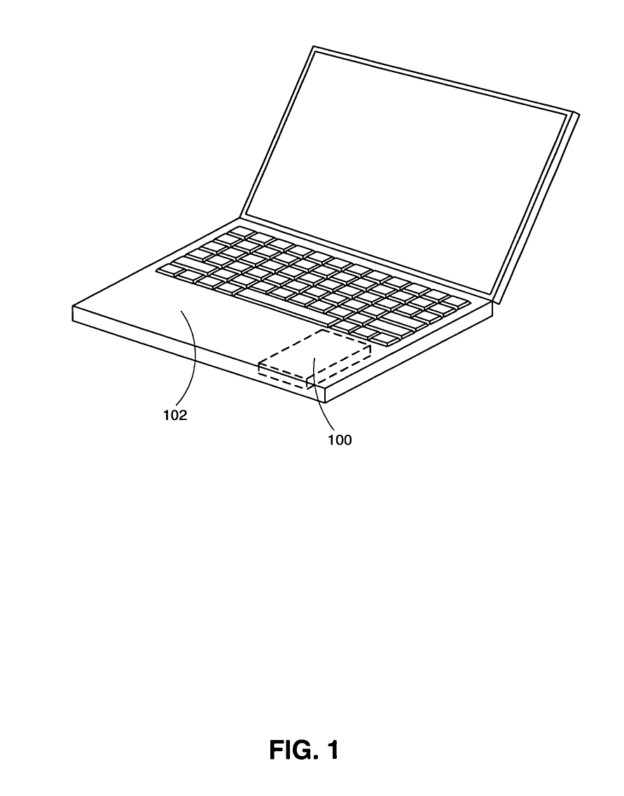

FIG. 1 illustrates one embodiment of a mobile computing device containing a rechargeable fuel cell module. A rechargeable fuel cell module 100 is contained within a mobile computing device 102. In different embodiments, the mobile computing device may be a cellular phone, a laptop computer, a personal digital assistant, or any other electrically operated mobile computing device. The rechargeable fuel cell module may be one of a number of types of fuel cells. In one embodiment, the rechargeable fuel cell module is comprised of a hydrogen fuel cell. In this embodiment, the hydrogen fuel cell accepts hydrogen as fuel input. The fuel cell releases electricity and heat as byproducts of the chemical reaction that takes place between oxygen and hydrogen. Furthermore, the fuel cell also releases water vapor as a reaction product of the same chemical reaction (i.e. water vapor is the reaction product of the oxygen and hydrogen reactant products). In one embodiment, the rechargeable fuel cell module captures the electricity for use by the mobile computing device. In one embodiment, the rechargeable fuel cell module captures and stores the water vapor to be recycled into fuel to once again be input into the fuel cell. In another embodiment, the rechargeable fuel cell is a hydrocarbon fuel cell and accepts a hydrocarbon-type fuel. For example, the fuel may be natural gas, methanol, ethanol, butane, or propane.

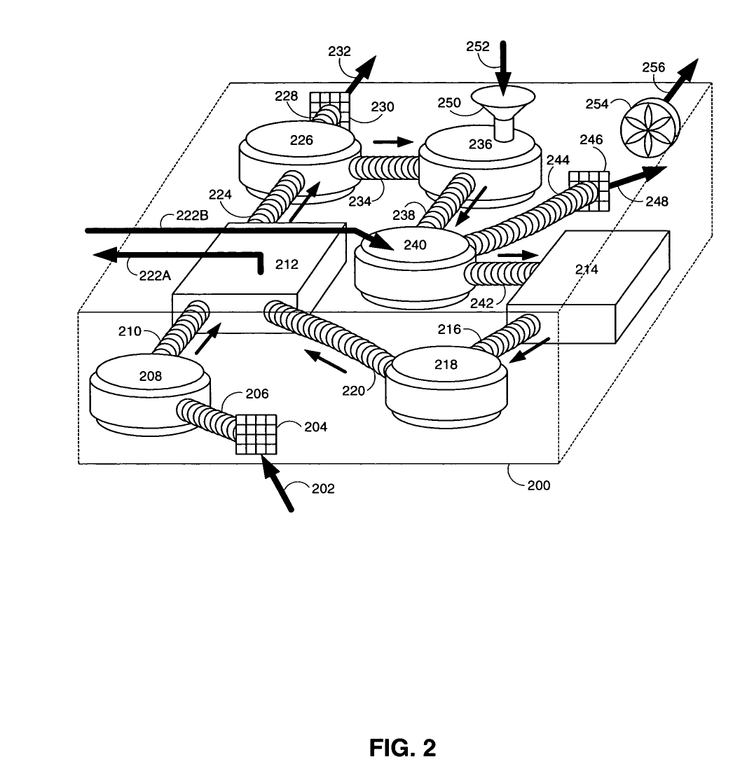

FIG. 2 illustrates one embodiment of a rechargeable fuel cell module. The rechargeable fuel cell module 200 has inputs of air 202 and water 252 (when necessary). When operational, the fuel cell module 200 outputs electricity 222A, heat 256, and reaction products 248. In one embodiment, the fuel cell module has a fuel cell stack 212 that is comprised of an anode, a cathode and an electrolyte membrane covered with a catalyst to accelerate the rate of the chemical reaction between the chemicals input into the anode side of the cell and the cathode side of the cell (i.e. the reactants). In one embodiment, the fuel cell is a hydrogen fuel cell. In a hydrogen fuel cell, the reactant input into the anode side of the fuel cell is hydrogen and the reactant input into the cathode side of the fuel cell is oxygen. Thus, in this embodiment, oxygen in the air 202 external to the rechargeable fuel cell (i.e. ambient air) module is input through vent 204 and tube 206 into air compressor 208. Air compressor 208 compresses the air and forces it through tube 210 into the fuel cell stack 212. In another embodiment, the fuel cell stack 212 does not require compressed air, thus air compressor 208 is replaced by a fan to direct the flow of air into the fuel cell stack 212.

Additionally, hydrogen is stored in fuel storage tank 214 for use by the fuel cell stack 212. In this embodiment, the hydrogen exits the fuel storage tank 214 through tube 216 into fuel pump 218. In one embodiment, the fuel storage tank 214 is a pressurized tank to hold pressurized gas. In this embodiment, the fuel storage tank 214 has an air compressor coupled to its input tube 242 to allow the pressurization of the gas as it flows into the pressurized tank. The fuel pump then pumps the hydrogen through tube 220 into the fuel cell stack 212. In another embodiment, the fuel pump is not necessary because the hydrogen is stored under a sufficient amount of pressure where it will automatically exit the fuel storage tank 214 and enter the fuel cell stack when allowed. Thus, in this embodiment, fuel pump 218 is replaced by a release valve to allow a sufficient amount of hydrogen to escape the fuel storage tank, pass through tubes 216 and 220, and enter into the fuel cell stack 212.

Once the hydrogen and oxygen reactants both enter the fuel cell stack 212 the chemical reaction begins to take place. Electricity, heat, and water vapor are produced from the chemical reaction (i.e. the reaction products). Electricity 222A is output from the rechargeable fuel cell module 200 for use by the mobile computing device. The heat and water vapor are expelled from the fuel cell stack through tube 224 into a reaction product recovery unit 226. The reaction product recovery unit 226 expels any excess heat 232 out of the rechargeable fuel cell module 200 through tube 228 and vent 230. Additionally, the reaction product recovery unit 226 recovers the water vapor and sends it through tube 234 into the reaction product storage unit 236. In one embodiment, the reaction product recovery unit 226 consists of a water condenser unit to condense the water vapor into liquid water for storage in the reaction product storage unit 236.

Next, the reaction product storage unit 236 sends the stored water through tube 238 to a fuel regeneration unit 240. The fuel regeneration unit 240 performs electrolysis on the water which splits the liquid water into the separate reactant products: hydrogen and oxygen. In one embodiment, the fuel regeneration unit 240 collects the water in an internal reservoir. Then an electrical potential is used to perform electrolysis on the water. The energy required to perform electrolysis on the water is provided by electricity 222B input into the fuel regeneration unit 240 from an external source when available. This external source of electricity 222B maintains the potential difference across the electrodes. In one embodiment, the electrolysis is performed when the mobile computing unit is plugged into an external source of electricity (e.g. a standard wall outlet of 110V, 220V, or some other standardized electricity outlet source). Thus, the electrolysis would be performed during points in time analogous to when a conventional mobile electronic device would be having its battery recharged with electricity. In one embodiment, the fuel regeneration unit expels the oxygen 248 produced by the electrolysis out of the rechargeable fuel cell module 200 through tube 244 and vent 246. In another embodiment, tube 244 is coupled to a second fuel storage device to store pure oxygen similar to fuel storage device 214 storing hydrogen. The second fuel storage device is coupled to the fuel cell stack to allow for oxygen to be input from an internal storage supply instead of from the ambient air. Returning to the operation of the fuel regeneration unit, the hydrogen produced from the electrolysis is sent through tube 242 into fuel storage tank 214 for storage.

The rechargeable fuel cell module 200 allows for the reactant products, hydrogen and oxygen, to be used and reused through the recycling of the water vapor reaction product. Due to expelled heat, electricity, and possibly oxygen from the otherwise closed rechargeable fuel cell module system, the recycled water reaction product (i.e. the hydrogen and oxygen) might deplete after a certain period of time. Thus, in one embodiment, the rechargeable fuel cell module 200 inputs external water 252 into the reaction product storage unit 236 through funnel 250. In one embodiment, funnel 250 is a one way funnel, in other words, the water can be poured into the reaction product storage unit 236 but it will not be able to exit back out the funnel. In another embodiment, funnel 250 has a cap that can close and keep the water poured in from escaping out of the funnel 250.

Furthermore, the rechargeable fuel cell module components may generate some additional heat on their own due to normal operations. Thus, in one embodiment, a fan 254 expels heated air 256 out of the rechargeable fuel cell module 200.

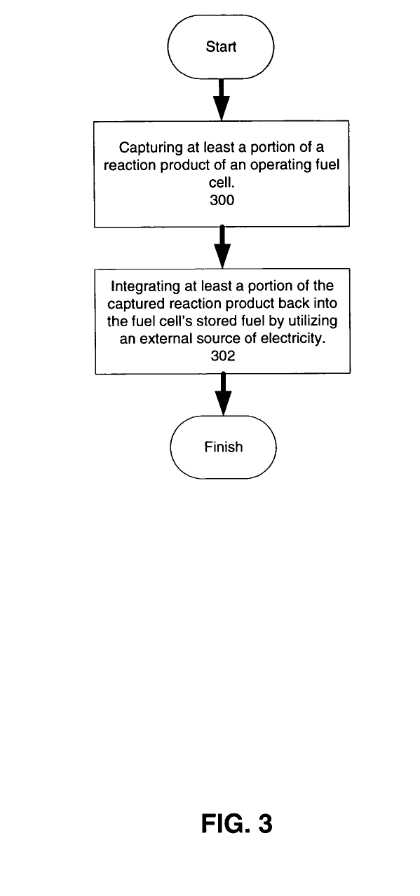

FIG. 3 is a flow diagram of one embodiment of a process to recharge a fuel cell's fuel supply with at least a portion of a reaction product expelled from the operating fuel cell. The process is performed by processing logic that may comprise hardware (machinery, circuitry, dedicated logic, etc.), software (such as is run on a general purpose computer system or a dedicated machine), or a combination of both. Referring to FIG. 3, the process begins by processing logic capturing at least a portion of a reaction product of an operating fuel cell (processing block 300). In one embodiment, the fuel cell is a hydrogen fuel cell and the reaction product is water vapor. In one embodiment, the water vapor is condensed into water. Next, processing logic converts at least a portion of the captured reaction product back into the fuel cell's stored fuel by utilizing an external source of electricity (processing block 302) and the process is finished. In one embodiment, the processing logic separates the hydrogen and oxygen in the water using electrolysis and integrates the hydrogen back into the fuel cell's stored fuel supply.

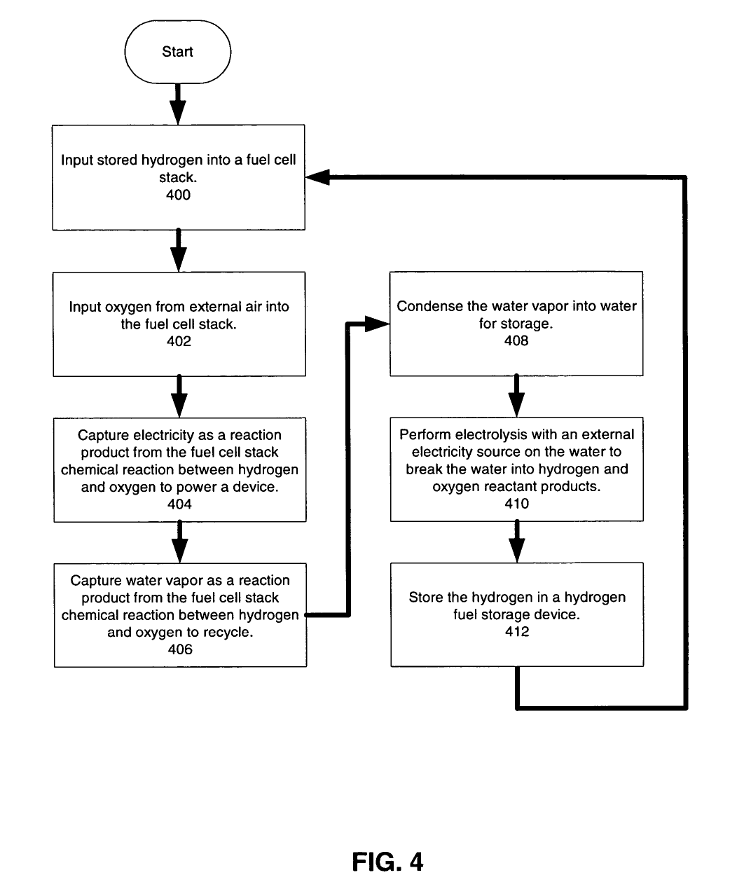

FIG. 4 is a flow diagram of one embodiment of a process to recharge a fuel cell's fuel supply with at least a portion of a reaction product expelled from the operating fuel cell. The process is performed by processing logic that may comprise hardware (machinery, circuitry, dedicated logic, etc.), software (such as is run on a general purpose computer system or a dedicated machine), or a combination of both. Referring to FIG. 4, the process begins by processing logic inputting stored hydrogen into a fuel cell stack (processing block 400). In one embodiment, inputting stored hydrogen into the fuel cell stack can be accomplished by a fuel pump. In another embodiment, the stored hydrogen is under pressure and releasing it from the pressurized storage device will force the hydrogen into the fuel cell stack without the need for a fuel pump. Next, the process continues by processing logic inputting oxygen from the ambient air into the fuel cell stack (processing block 402). In one embodiment, the air is pressurized by an air compressor to force the air into the fuel cell stack. In another embodiment, a fan is used to create a flow of ambient air into the fuel cell stack. The fuel cell stack, having the two reactant products necessary to be operational (i.e. the oxygen and the hydrogen), begins to operate and electricity, heat, and water vapor are produced.

Then processing logic captures electricity as a reaction product from the fuel cell stack chemical reaction between the hydrogen and oxygen to power a device (processing block 404). In different embodiments, the device being powered is a laptop computer, a cellular phone, a personal digital assistant, or any other form of electronic device that utilizes stored energy for power (e.g. any mobile device that typically would use a battery with current technology). Next, processing logic captures water vapor as a reaction product from the fuel cell stack chemical reaction between the hydrogen and oxygen to recycle (processing block 406).

After the water vapor is captured, processing logic condenses the water vapor into water for storage (processing block 408). Next, processing logic performs electrolysis with an external electricity source on the water to break the water into hydrogen and oxygen reactant products (processing block 410). In one embodiment, the external electricity source is a standard wall outlet plug, which allows the electrolysis to take place without any energy necessary from the fuel cell stack.

Finally, processing logic stores the hydrogen captured from the electrolysis process in a hydrogen fuel storage device (processing block 412) and the process repeats itself. In one embodiment, the hydrogen fuel storage device is a pressurized tank for storing a greater amount of hydrogen in the same volume of space.

Thus, embodiments of an effective method to recharge a fuel cell's fuel supply with a portion of one or more reaction products expelled from the operating fuel cell are disclosed. These embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
capturing at least a portion of a reaction product of an operating fuel cell; and
converting at least a portion of the captured reaction product by utilizing an external source of electricity to create fuel that is stored back into the fuel cell's stored fuel supply.

2. The method of claim 11, wherein integrating at least a portion the captured reaction product back into the fuel cell's stored fuel by utilizing an external source of electricity further comprises:
performing electrolysis on at least a portion of the reaction product by passing electricity from a source external to the fuel cell through the reaction product to produce one or more reactants; and
storing at least one of the one or more reactants in a fuel storage device.

3. The method of claim 2, wherein the fuel cell comprises a hydrogen fuel cell.

4. The method of claim 3, wherein the stored reactant comprises hydrogen.

5. The method of claim 4, wherein the reaction product comprises water vapor.

6. The method of claim 5, further comprising condensing the water vapor to store as liquid water.

7. The method of claim 4, further comprising:
forcing ambient air containing oxygen into the fuel cell;
forcing the stored hydrogen created from the electrolysis performed on the reaction product into the fuel cell;
capturing electricity generated from the fuel cell reaction between hydrogen and oxygen; and
capturing the water vapor reaction product.

8. The method of claim 2, further comprising operating the fuel cell at least partially using the stored reactant as a fuel for the fuel cell.

9. A system, comprising:
a fuel cell;
a reaction product recovery unit to capture at least a portion of a reaction product discharged from the fuel cell; and
a fuel regeneration unit to convert at least a portion of the captured reaction product back into fuel for the fuel cell by utilizing an external source of electricity.

10. The system of claim 9, further comprising a fuel storage device to store the fuel for the fuel cell.

11. The system of claim 10, wherein the fuel regeneration unit is further operable to:
perform electrolysis on the reaction product by passing electricity from a source external to the system through the reaction product to produce one or more reactants; and
store at least one of the one or more reactants created by the electrolysis in the fuel storage device.

12. The system of claim 11, wherein the fuel cell is further comprised of a hydrogen fuel cell.

13. The system of claim 12, wherein the stored reactant comprises hydrogen.

14. The system of claim 13, wherein the reaction product comprises water vapor.

15. The system of claim 14, further comprising:
a water condenser operable to condense the water vapor into water; and
a reservoir operable to store the water.

16. The system of claim 15, further comprising a one-way funnel coupled to the reservoir operable to allow the introduction of water external to the system into the reservoir.

17. The system of claim 15, further comprising an ambient air capture device operable to force ambient air containing oxygen into the fuel cell.

18. The system of claim 17, wherein the system:
forces the stored hydrogen created from the electrolysis performed on the reaction product into the fuel cell;
captures electricity generated from the fuel cell reaction between hydrogen and oxygen; and
captures the water vapor reaction product.

19. The system of claim 18, further comprising operating the fuel cell at least partially using the stored reactant as a fuel for the fuel cell.

20. The system of claim 17, wherein the ambient air capture device comprises an air compressor.

21. The system of claim 17, wherein the ambient air capture device comprises a fan.

22. The system of claim 12, wherein the fuel storage device comprises a pressurized tank.

23. The system of claim 12, wherein the system further comprises a rechargeable electricity production unit for a mobile computing device.

24. The system of claim 23, wherein the external source of electricity comprises a standard electric outlet.

25. An apparatus, comprising:
a reaction product recovery unit to capture at least a portion of a reaction product discharged from a fuel cell; and
a fuel regeneration unit to convert at least a portion of the captured reaction product back into fuel for the fuel cell by utilizing an external source of electricity.

26. The apparatus of claim 25, wherein the fuel regeneration unit is further operable to perform electrolysis on the reaction product by passing electricity from an external source through the reaction product to produce one or more reactants.

27. The apparatus of claim 26, further comprising a fuel storage unit to store at least one of the one or more reactants created by the electrolysis in the fuel storage device.

28. The apparatus of claim 27, wherein the fuel cell comprises a hydrogen fuel cell.

29. The apparatus of claim 28, wherein the stored reactant comprises hydrogen.

30. The apparatus of claim 29, wherein the reaction product comprises water vapor.

31. The apparatus of claim 30, further comprising:
a water condenser operable to condense the water vapor into liquid water; and
a reservoir operable to store the liquid water.

32. The apparatus of claim 31, further comprising a one-way funnel coupled to the reservoir operable to allow the introduction of water external to the system into the reservoir.

33. The apparatus of claim 31, further comprising an ambient air capture device operable to force ambient air containing oxygen into the fuel cell.

34. The apparatus of claim 33, further operable to:
force the stored hydrogen created from the electrolysis performed on the reaction product into the fuel cell;
capture electricity generated from the fuel cell reaction between hydrogen and oxygen; and
capture the water vapor reaction product.

35. The apparatus of claim 33, wherein the ambient air capture device comprises an air compressor.

36. The system of claim 33, wherein the ambient air capture device comprises a fan.

37. The apparatus of claim 27, wherein the stored reactant comprises a fuel for the operating fuel cell.

38. The apparatus of claim 37, further comprising operating the fuel cell at least partially using the stored reactant as a fuel for the fuel cell.

39. The apparatus of claim 27, wherein the fuel storage device comprises a pressurized tank.

40. The apparatus of claim 27, further operable to function as a rechargeable electricity production unit for a mobile computing device.

41. The apparatus of claim 27, wherein the external source of electricity comprises a standard electric outlet.
